(19) United States
(12) Patent Application Publication
(10) Pub. No.: US 2026/0254896 A1
(43) Pub. Date: Aug. 27, 2026

(54) SYSTEMS AND METHODS FOR AUTOMATIC NON-EMERGENCY CALL HANDLING

(71) Applicant: CENTRALSQUARE TECHNOLOGIES, LLC, Lake Mary, FL (US)

(72) Inventor: Jordan WITT, Calmar, IA (US)

(73) Assignee: CENTRALSQUARE TECHNOLOGIES, LLC, Lake Mary, FL (US)

(21) Appl. No.: 19/548,602

(22) Filed: Feb. 24, 2026

Related U.S. Application Data
(60) Provisional application No. 63/762,986, filed on Feb. 25, 2025.

(51) Int. Cl. H04M 3/51; H04M 3/523

(52) U.S. Cl. CPC H04M 3/5141; H04M 3/5191; H04M 3/5235

(57) ABSTRACT

Systems and methods for automatic non‑emergency call handling that helps public safety agencies are disclosed. A memory stores instructions which are executed by at least one processor to receive a call from a reporting party device and gather basic details to decide whether the call is regarding an emergency. If more information is needed, the call is passed to an artificial intelligence component that gathers follow up information and interprets the caller’s intent. For confirmed non-emergencies, the system may direct the caller to an online reporting tool and collect incident details to store them in a records system and create a dispatchable record when appropriate. Disclosed systems and methods for automatic non‑emergency call handling reduces call taker workload and improves the efficiency of non-emergency call processing.

### CROSS-REFERENCE TO RELATED APPLICATION

This application claims the benefit of priority of United States Provisional Patent Application No. 63/762,986, filed on February 25, 2025, the entire contents of which are incorporated herein by reference.

### TECHNICAL FIELD

The present disclosure generally relates to systems and methods for non-emergency call handling in Public Safety Answering Points (PSAPs) and, more particularly, to systems and methods for automatic non-emergency call handling in Public Safety Answering Points (PSAPs).

### BACKGROUND

Public Safety Answering Points (PSAPs) are critical components of emergency response systems because they serve as the primary point of contact for individuals seeking help in emergency situations. PSAPs are staffed with professionals who handle incoming calls to route them to appropriate emergency services, ensuring rapid dispatch of assistance. However, PSAPs face challenges in managing and responding to high call volumes. Most of PSAPs in the U.S. report being understaffed, which results in longer wait times for citizens during critical moments.

These challenges are exacerbated by a high volume of non-emergency calls to the PSAPs. Non-emergency calls can range from inquiries about non-urgent matters to administrative issues. Non-emergency calls increase the workload on PSAP personnel, resulting in unnecessary delay in the response to true emergency situations. PSAP personnel spend time classifying the degree of emergency in calls they receive so that they can route calls to appropriate resources. Since PSAPs remain primarily focused on emergency call handling, the diversion of resources for non-emergency matters creates inefficiencies in emergency response systems.

Attempts to improve the efficiency and effectiveness of call handling in PSAPs have been made but with limited success. For example, implementing certain solutions to relieve the call volume received at PSAPs such as allowing citizens to report non-emergency incidents online directly have not been successful. This may be in part because a citizen who wants to report an incident still has to call in, wait on hold, and speak to a staff member until the staff classifies the incident and directs the caller to a specific online resource. This solution still ties up PSAP response personnel even if citizens ultimately end up reporting their incidents online. Improving the efficiency and effectiveness of call handling in PSAPs via better handling of non-emergency calls presents unique challenges due to the need to process large amounts of complex data delivered in high call volumes.

Accordingly, there is a need to improve non-emergency call handling by PSAPs.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1A is a block diagram illustrating an exemplary system for automatic non-emergency call handling, consistent with disclosed embodiments.

FIG. 1B is a simplified block diagram illustrating an exemplary system for automatic non-emergency call handling, consistent with disclosed embodiments.

FIG. 2 is a flow diagram of an exemplary embodiment for automatic non-emergency call handling, consistent with disclosed embodiments.

FIG. 3 is a block diagram of an exemplary computing device that may be employed in connection with disclosed embodiments.

### SUMMARY

Embodiments of the present disclosure may provide a memory storing instructions that, when executed by at least one processor, cause the at least one processor to perform operations for automatic non-emergency call handling. Instructions may include receiving, from a reporting party device, a call regarding an incident from a reporting party, the call including non-emergency calls. The instructions may further include initiating a response input component for the reporting party, to determine if the call is regarding a non-emergency incident and, upon determining the call is regarding a non-emergency incident, report the non-emergency incident. The instructions may further include routing, if the response input component is not able to determine if the call is regarding a non-emergency incident, the call to an artificial intelligence component, the artificial intelligence component configured to gather further information. The instructions may further include determining, using the artificial intelligence component, if the call is regarding a non-emergency incident and, if the call is regarding a non-emergency incident, report the non-emergency incident. The instructions may further include transferring, if the artificial intelligence component is not able to determine if the call is regarding a non-emergency incident, the call to an external system.

According to an embodiment of the present disclosure, the instructions may further include receiving, if the call is regarding a non-emergency incident, the non-emergency incident information from the reporting party device. The instructions may further include assigning metadata including timestamps and device type associated with the non‑emergency incident. The instructions may further include storing the information in a database via a records management component.

According to an embodiment of the present disclosure, the instructions may further include generating, if the call is regarding a non-emergency incident, a corresponding dispatchable incident record via a computer-aided dispatch component.

According to an embodiment of the present disclosure, the computer-aided dispatch component may be further configured to export the dispatchable incident record to one or more external public safety systems.

According to an embodiment of the present disclosure, the response input component may be an interactive voice response system.

According to an embodiment of the present disclosure, the response input component may be configured to transmit, upon determining the call is regarding a non‑emergency incident, a hyperlink to an online incident reporting application to the reporting party device.

According to an embodiment of the present disclosure, the online incident reporting application may be further configured to receive multimedia content from the reporting party device, including one or more of images, audio files, or video files, for non‑emergency incident reporting.

According to an embodiment of the present disclosure, the artificial intelligence component may be a virtual contact center supported by generative machine-learning agents.

According to an embodiment of the present disclosure, the artificial intelligence component may be configured to send, upon determining the call is regarding a non‑emergency incident, a hyperlink to an online incident reporting application to the reporting party device.

According to an embodiment of the present disclosure, the artificial intelligence component may be further configured to evaluate reporting party intent using a machine‑learning model trained on public safety answering point (PSAP) call data.

According to an embodiment of the present disclosure, the at least one processor may be further configured to log each routing decision, including determinations made by the response input component and the artificial intelligence component, in a database.

According to an embodiment of the present disclosure, the at least one processor may be further configured to bypass automatic non-emergency call handling and transfer the call out of the system when the reporting party indicates a desire to speak directly with a live dispatcher.

According to an embodiment of the present disclosure, the at least one processor may be further configured to transfer the call out of the system after a predetermined number of unanswered prompts.

Embodiments of the present disclosure may provide a method for automatic non-emergency call handling. The method may include receiving, from a reporting party device, a call regarding an incident from a reporting party, the call including non-emergency calls. The method may further include initiating a response input component for the reporting party, to determine if the call is regarding a non-emergency incident and, upon determining the call is regarding a non-emergency incident, report the non-emergency incident. The method may further include routing, if the response input component is not able to determine if the call is regarding a non-emergency incident, the call to an artificial intelligence component, the artificial intelligence component configured to gather further information. The method may further include determining, using the artificial intelligence component, if the call is regarding a non-emergency incident and, if the call is regarding a non-emergency incident, report the non-emergency incident. The method may further include transferring, if the artificial intelligence component is not able to determine if the call is regarding a non-emergency incident, the call to an external system.

The systems and methods disclosed herein may be used in various applications and business systems. It is to be understood that the foregoing general description and the following detailed description are exemplary and explanatory only and are not restrictive of the disclosed embodiments.

### DETAILED DESCRIPTION

Before explaining certain embodiments of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the accompanying drawings, are for the purpose of description and should not be regarded as limiting.

As such, those skilled in the art will appreciate that the conception upon which this disclosure is based may readily be utilized as a basis for designing other structures, methods, and systems for carrying out the several purposes of the present disclosure.

Reference will now be made in detail to the present exemplary embodiments of the invention, examples of which are illustrated in the accompanying drawings. Wherever possible, the same reference numbers will be used throughout the drawings to refer to the same or like parts.

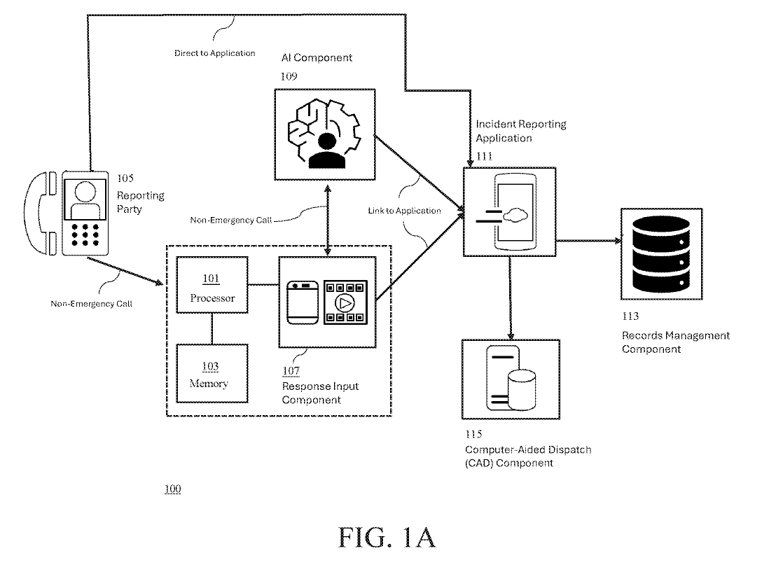

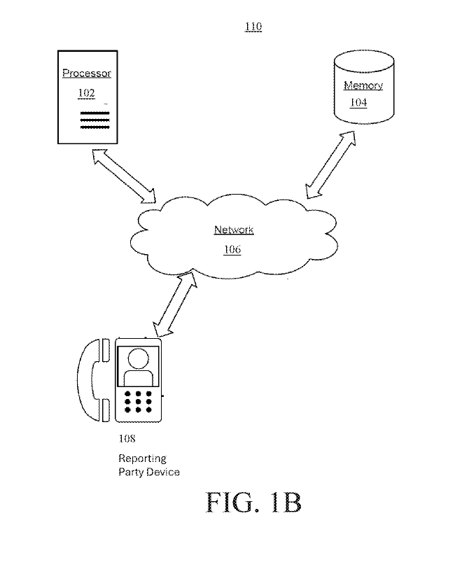

FIG. 1 is a block diagram illustrating a system 100 for automatic non-emergency call handling, consistent with disclosed embodiments. System 100 may integrate multiple technologies, including a response input component 107, an artificial intelligence (AI) component 109, an incident reporting application 111, a records management component 113, and a computer-aided dispatch (CAD) component 115. Each technology is described in detail below.

A reporting party 105 may call a non-emergency line for a Public Safety Answering Point (PSAP) to report an incident. Reporting party 105 may be an individual witnessing or involved in the incident. Reporting party 105 may call from a telecommunication device such as landline phone, mobile phone, Voice over Internet Protocol (VoIP) device, or other voice communications device to report the incident. A processor 101 may receive the call regarding the incident and may direct the call to a response input component 107. Response input component 107 may collect information about the incident via interactions with reporting party 105. In some embodiments, response input component 107 may be Interactive Voice Response (IVR) technology that enables interaction between reporting party 105 and a computer system through voice and keypad inputs. In some embodiments, IVR technology may utilize pre-recorded voice prompts and menus to guide users through a series of choices or actions to route calls out of system 100 or to other appropriate parts of system 100 over a network such as Public Switched Telephone Network (PSTN). In some embodiments, a response input component may be Vertex^{TM} NG911, an IVR solution designed to enable efficient and comprehensive communication between PSAPs, emergency responders, and the general public within a Next Generation 911 (NG911) framework, which is an internet protocol (IP) based system aimed to replace the current analog 911 infrastructure. The communication may occur via audio calls, texts, video calls, or sending pictures.

Response input component 107 may determine whether the call is regarding a non-emergency after collecting initial information from reporting party 105. If response input component 107 determines the call is regarding an emergency, it may route the call out of system 100 and may transfer the call to an emergency line. If response input component 107 determines the call is regarding a non-emergency, it may direct reporting party 105 to incident reporting application 111. In some embodiments, response input component 107 may send the reporting party a short message service (SMS) text message with a link to an online citizen reporting website to report the incident and the call may be terminated. If response input component 107 is unable to determine whether the call is regarding a non-emergency, it may route the call to AI component 109 to collect further information about the incident.

AI component 109 may interact with reporting party 105 using natural language processing to discover the party’s intent and gather further information that could have not been collected via response input component 107. AI component 109 may determine whether the call is regarding a non-emergency after collecting further information from reporting party 105. If AI component 109 determines the call is regarding an emergency, it may route the call out of system 100 and may transfer the call to an emergency line for a PSAP or it may alert reporting party 105 to call 911. If AI component 109 determines the call is regarding a non-emergency, it may direct reporting party 105 to incident reporting application 111. If AI component 109 is unable to determine whether the call is regarding a non-emergency, it may route the call to PSAP response personnel.

Reporting party 105 may also access incident reporting application 111 directly to report the incident, bypassing response input component 107 or AI component 109. Incident reporting application 111 may provide a central platform for reporting an incident. A central platform may refer to any hardware or software hosting a web application infrastructure that allows the application to run. Reporting party 105 may submit a non-emergency incident report without talking to PSAP response personnel.

Incident reporting application 111 may be accessed by a computing device. A computing device may be a mobile device, desktop, laptop, tablet, or any other device capable of accessing incident reporting application 111. Reporting party 105 may provide incident details such as reporting party name, contact information, detailed description of the incident, date and time of the incident, and/or urgency through the central platform provided by incident reporting application 111. When reporting party 105 submits the incident details via incident reporting application 111, incident-related data may be stored in records management component 113 and/or computer-aided dispatch component 115.

Records management component 113 may include a database to store incident details. In some embodiments, records management component 113 contains and manages public safety and law enforcement cases and non-emergency incident reports. Computer-aided dispatch component 115 may refer to a technology used by emergency call centers or dispatch centers to manage and coordinate emergency and non-emergency response activities. In some embodiments, computer-aided dispatch component 115 may utilize standardized data sharing protocols to receive information from external sources. For example, computer-aided dispatch component 115 may integrate with public safety answering points (PSAPs) using protocols such as the National Emergency Number Association’s (NENA) standard for data exchange between PSAPs and computer-aided dispatch component 115. When the incident details via incident reporting application 111 get stored in records management component 113 and/or computer-aided dispatch component 115, the incident may be resolved later by a response personnel member.

### System, Processor, Memory, and Network

FIG. 1B is a simplified block diagram illustrating an exemplary system 110 for automatic non-emergency call handling, consistent with disclosed embodiments. Response input component 107, artificial intelligence (AI) component 109, incident reporting application 111, records management component 113, and computer-aided dispatch (CAD) component 115 may be implemented by system 110. System 110 may include at least one processor 102 and at least one memory 104. Processor 102 may be a part of one of the components of system 100 that may be presently handling a reporting party call. System 110 may also include a network 106 and a reporting party device 108. Reporting party device 108 may be a telecommunication device such as a landline phone, mobile phone, Voice over Internet Protocol (VoIP) device or other voice communications device to report incidents. In system 110, at least one processor 102 and at least one memory 104 may communicate with each other via network 106, at least one processor 102 and reporting party device 108 may communicate with each other over network 106, and reporting party device 108 and at least one memory 104 may communicate with each other over network 106.

Consistent with disclosed embodiments, the embodiments may involve a network (e.g., 106). The network may constitute any type of physical or wireless computer networking arrangement used to exchange data between, for example, at least one processor 102, at least one memory 104, and/or reporting party device 108. For example, the network may be the Internet, a private data network, a virtual private network using a public network, a Wi-Fi network, a LAN or WAN network, a combination of one or more of the foregoing, and/or other suitable connections that may enable information exchange among various components of the system. In some embodiments, the network may include one or more physical links used to exchange data, such as Ethernet, coaxial cables, twisted pair cables, fiber optics, or any other suitable physical medium for exchanging data. The network may also include a public switched telephone network (“PSTN”) and/or a wireless cellular network. The network may be a secured network or unsecured network.

Consistent with disclosed embodiments, each of the at least one processors 101 and/or 102 discussed herein and illustrated FIG. 1A and 1B may constitute any physical device or group of devices having electronic circuitry that performs a logic operation on an input or inputs. For example, the processor may include one or more integrated circuits (IC), including an application-specific integrated circuit (ASIC), microchips, microcontrollers, microprocessors, all or part of a central processing unit (CPU), a graphics processing unit (GPU), a digital signal processor (DSP), a field-programmable gate array (FPGA), a server, a virtual server, or other circuits suitable for executing instructions or performing logic operations. In some embodiments, the at least one processor 101 or 102 may include more than one processor. Each processor of the more than one processors may have similar construction or the processors of the more than one processors may be of differing constructions that are electrically connected or disconnected from each other. For example, the processors (e.g., 101 and/or 102) may be separate circuits or integrated in a single circuit. When more than one processor (e.g., 101 and/or 102) is used, the processors (e.g., 101 and/or 102) may be configured to operate independently or collaboratively, and may be co-located or located remotely from each other. The processors may be coupled electrically, magnetically, optically, acoustically, mechanically or by any other means that permit them to interact.

The instructions executed by the at least one processors (e.g., 101 and/or 102) may, for example, be pre-loaded into a memory (e.g., 103 and/or 104), integrated with or embedded into the controller or may be stored in a separate memory. Each of memories 103 and 104 may include a Random Access Memory (RAM), a Read-Only Memory (ROM), a hard disk, an optical disk, a magnetic medium, a flash memory, other permanent, fixed, or volatile memory, or any other mechanism capable of storing instructions. As used herein, a memory (e.g., 103 and/or 104), may be any type of physical memory in which information or data readable by at least one processor may be stored. Examples of memory include Random Access Memory (RAM), Read-Only Memory (ROM), volatile memory, non-volatile memory, hard drives, CD ROMs, DVDs, flash drives, disks, any other optical data storage medium, any physical medium with patterns of holes, markers, or other readable elements, a PROM, an EPROM, a FLASH-EPROM or any other flash memory, NVRAM, a cache, a register, any other memory chip or cartridge, and networked versions of the same.

The term “memory” (e.g., memory 103 and/or 104) may refer to multiple structures, such as a plurality of memories or computer-readable storage media located within an input unit or at a remote location. Additionally, one or more computer-readable storage mediums may be utilized in implementing a computer-implemented method. The memory may include one or more separate storage devices collocated or disbursed, capable of storing data structures, instructions, or any other data. The memory may further include a memory portion containing instructions for the processor to execute. The memory may also be used as a working scratch pad for the processors (e.g., processors 101 and/or 102) or as a temporary storage. Accordingly, the term computer-readable storage medium should be understood to include tangible items and exclude carrier waves and transient signals.

Disclosed embodiments may include and/or access a data structure. A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB^{®}, Redis^{®}, Couchbase^{®}, Datastax Enterprise Graph, Elastic Search^{®}, Splunk^{®}, Solr^{®}, Cassandra^{®}, Amazon DynamoDB^{®}, Scylla^{®}, HBase^{®}, and Neo4J^{®}. A data structure may be a component of disclosed system 110, a component of a database, or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. Thus, the term “data structure” as used herein in the singular is inclusive of plural data structures.

Various embodiments are described herein with reference to a system, method, device, or computer-readable medium. It is intended that the disclosure of one is a disclosure of all. For example, it is to be understood that disclosure of a computer-readable medium described herein also constitutes a disclosure of methods implemented by the computer-readable medium, and systems and devices for implementing those methods, via for example, at least one processor (e.g., 101 and/or 102). It is to be understood that this form of disclosure is for ease of discussion only, and one or more aspects of one embodiment herein may be combined with one or more aspects of other embodiments herein, within the intended scope of this disclosure.

Embodiments described herein may refer to a non-transitory computer-readable medium containing instructions that when executed by at least one processor (e.g., 101 and/or 102), cause the at least one processor to perform a method. Non-transitory computer-readable mediums may be any medium capable of storing data in any memory (e.g., 103 and/or 104) in a way that may be read by any computing device with a processor (e.g., 101 and/or 102) to carry out methods or any other instructions stored in the memory (e.g., 103 and/or 104). The non-transitory computer-readable medium may be implemented as hardware, firmware, software, or any combination thereof. Moreover, the software may preferably be implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine may be implemented on a computer platform having hardware such as one or more central processing units (“CPUs”) (e.g., 101 and/or 102), a memory (e.g., 103 and/or 104), and input/output interfaces. The computer platform may also include an operating system and microinstruction code. The various processes and functions described in this disclosure may be either part of the microinstruction code or part of the application program, or any combination thereof, which may be executed by a CPU, whether or not such a computer or processor (e.g., 101 and/or 102) is explicitly shown. In addition, various other peripheral units may be connected to the computer platform such as an additional data storage unit and a printing unit. Furthermore, a non-transitory computer-readable medium may be any computer-readable medium except for a transitory propagating signal.

Processor 101 and/or 102 may run computer applications. Applications may be mobile computer programs configured to run on mobile phones or tablet computers. Applications may also be computer programs configured to run on laptop computers or desktop computers. Computer applications are computer software packages designed to carry out specific tasks. Some applications may be front-end applications that interact directly with of a computer or mobile device user. Back-end applications may handle and process requests from front-end applications, manage data, and perform call-handling logic. Back-end applications may consist of a variety of services, including application program interfaces, microservices, and other middleware components. Back-end applications may operate behind the scenes, providing the necessary infrastructure to support the user-facing elements of front-end applications. A front-end application may call the back-end application to process data or to retrieve or access data.

### Automatic Non-Emergency Call Handling

Embodiments described herein may refer to methods that include various steps. Unless the order is characterized as necessary, the steps of methods described herein may be performed in any order possible to achieve the results of the method.

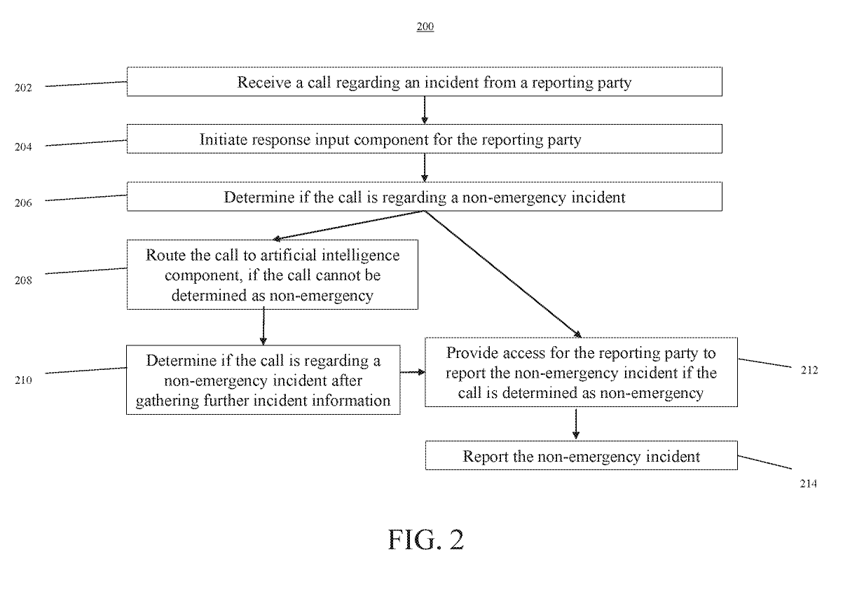

FIG. 2 is a flow diagram illustrating an exemplary method 200 for automatic non-emergency call handling. Method 200 may be practiced on system 110. Method 200 may be used to receive calls from reporting parties. Method 200 may process the calls, including non-emergency calls, by initiating a response input component, consistent with disclosed embodiments, to collect incident details and by routing the calls to appropriate components of system 100. In some embodiments, a response input component such as IVR may determine whether a call is regarding a non-emergency from input provided by a reporting party and may send an SMS text message with a link to an online citizen reporting website to report the non-emergency. In other embodiments, the IVR may be unable to determine whether a call is regarding a non-emergency from input provided by a reporting party and transfer the call to an AI component to collect further information. In some embodiments, the AI component may be services provided and operated by a third-party. Based on the further information provided, the AI component may determine that the call is regarding a non-emergency and may send an SMS text message with a link to an online citizen reporting website to report the non-emergency.

Method 200 may include a step 202 of receiving a call regarding an incident from a reporting party, the call including a non-emergency call. The reporting party may call to report incidents, including non-emergency incidents. The reporting party may call from a telecommunication device such as landline phone, mobile phone, Voice over Internet Protocol (VoIP) device or other voice communications device to report the incidents. In some embodiments, the calls may be received over the Public Switched Telephone Network (PSTN).

Method 200 may include a step 204 of initiating a response input component for the reporting party. The response input component may collect incident details via interactions with the reporting party through voice and/or keypad inputs from the call from a reporting party device. When the call is received, the response input component may answer the call with an initial greeting, which may be a pre-recorded message or a text-to-speech (TTS) response. The response input component then may prompt the reporting party to press a number on a telecommunication device keypad or to speak a command. Recognizing the number pressed or the command, the response input component may process the input from the reporting party and take an appropriate action to route the call or to terminate the call. For example, the response input component may transfer the call to a live PSAP response personnel member when there is a need for more sophisticated assistance that cannot be provided by the response input component or when there is an emergency that cannot be resolved by method 200. In another example, the response input component may route the call to a more sophisticated technology to collect further information. In some embodiments, a response input component may be an Interactive Voice Response (IVR) technology such as Vertex^{TM} NG911 Call Handling, a call-taking solution that provides the tools to control and prioritize resources at PSAPs.

Method 200 may include a step of 206 of determining if the call is regarding a non-emergency incident. The response input component may have capability to route the call to a different technology over a network. The response input component may integrate with backend technologies such as databases and servers and with frontend technologies such as web applications or other applications to provide more complex functionalities after initial collection of reporting party’s incident information. Based upon initial incident data collected from the call, the response input component may determine if the call is regarding a non-emergency incident. For example, by comparing the criteria set by a PSAP (e.g., nature of incident, severity, threat to life or property, urgency, risk of escalation, etc.) and the criteria identified with voice and/or keypad inputs from the call from the reporting party, the response input component may be able to determine whether the call is regarding a non-emergency incident. Sometimes, the response input component may be unable to determine whether a call is regarding a non-emergency incident with inputs provided from the reporting party. In some embodiments, depending on whether the response input component may be able to determine if the call is regarding a non-emergency, the response input component may route the call to a different technology such as an AI call-handling application or direct the reporting party to a web application to report the incident.

Method 200 may include a step of 208 of routing, if the response input component is not able to determine if the call is regarding a non-emergency incident, the call to an artificial intelligence component. When the response input component is unable to determine whether the call from the reporting party is regarding a non-emergency incident, the response input component may route the call to the artificial intelligence component of the system, consistent with disclosed embodiments, over a network (e.g., PSTN, etc.).

Method 200 may include a step of 210 of an artificial intelligence component gathering further information to determine if the call is regarding a non-emergency incident. An artificial intelligence component may collect further incident details via interactions with the reporting party. The collection of information may occur as an artificial intelligence agent in the artificial intelligence component asking questions and the reporting party answering the questions. The artificial intelligence component may use natural language processing to communicate with the reporting party to discover the party’s intent (i.e., reason for calling) and match the intent with appropriate questions and answers that has been provided by a PSAP. In some embodiments, the artificial intelligence component may be a third-party provided service such as Amazon Connect^{®}, a virtual contact center supported by artificial intelligence agents.

The artificial intelligence component may have the capability to route the call to a different technology over a network. Based upon further incident data collected from the call, the artificial intelligence component may determine if the call is regarding a non-emergency incident. For example, by discovering the reporting party’s intent and analyzing the party’s answers, the artificial intelligence component may be able to determine whether the call is regarding a non-emergency incident. When the call is regarding a non-emergency incident, the artificial intelligence component may direct the reporting party to a web application to report the incident. When the artificial intelligence component is unable to determine whether a call is regarding a non-emergency incident with information provided, the call may be transferred out of the system, consistent with disclosed embodiments, and to a live PSAP response personnel member.

Method 200 may include a step of 212 of providing access to an incident reporting application through which the reporting party can report the non-emergency incident, if the call is regarding a non-emergency incident. The reporting party may report the incident via an incident reporting application, consistent with disclosed embodiments, if the incident is determined to be a non-emergency. The reporting party may report the non-emergency incident by accessing a web page or web pages provided by the incident reporting application, as described with respect to FIG. 1A. A web page may be a graphical user interface object that allows multiple input fields, buttons, panels, or sections to be contained within that page. Web pages may display lists, documents, or groups of information in a graphical user interface. In some embodiments, incident reporting application may be an online citizen reporting website. The reporting party may receive a short message service (SMS) text message with a link to the online citizen reporting website to report the incident when the response input component or the artificial intelligence component determines that the call from the reporting party is regarding a non-emergency incident. In some embodiments, the incident reporting application may be Online Citizen Reporting, an online incident reporting web application which includes a unique subdomain for a PSAP to link from the PSAP’s main website to direct citizens to that PSAP specific portal, a customizable user disclaimer page prior to entering a report, a standard set of incident types that can be submitted by citizens, and a PSAP-defined email address to receive report submissions or report notifications among other features. Through the incident reporting application, the reporting party may submit the non-emergency incident report without connecting to the PSAP. The reporting party may provide the reporting party name, contact information, a detailed description of the incident, date and time of the incident, urgency, severity, threat to life or property, and/or other incident-related information via the incident reporting application.

Method 200 may include a step of 214 of reporting the non-emergency incident. Reporting the incident may include steps of receiving the non-emergency incident information from the reporting party and sending the information to a database for storage. Incident-related information provided by the reporting party in step 212 may be stored in databases for a records management component and/or the computer-aided dispatch component, consistent with disclosed embodiments. When the incident details via incident reporting application get stored in records management component and/or computer-aided dispatch component, the incident may be resolved later by an appropriate response personnel member. In some embodiments, records management component may be Records Enterprise, a cloud-based solution that allows sharing received information about an incident across multiple technologies, such as the computer-aided dispatch component. In some embodiments, the computer-aided dispatch component may be CAD Enterprise, an on-premise or cloud-hosted technology to maximize interoperability between PSAP departments for more coordinated responses to reported incidents.

Embodiments described herein may refer to methods that include various steps. Unless the order is characterized as necessary, the steps of methods described herein may be performed in any order possible to achieve the results of the method.

### Exemplary Computing Device

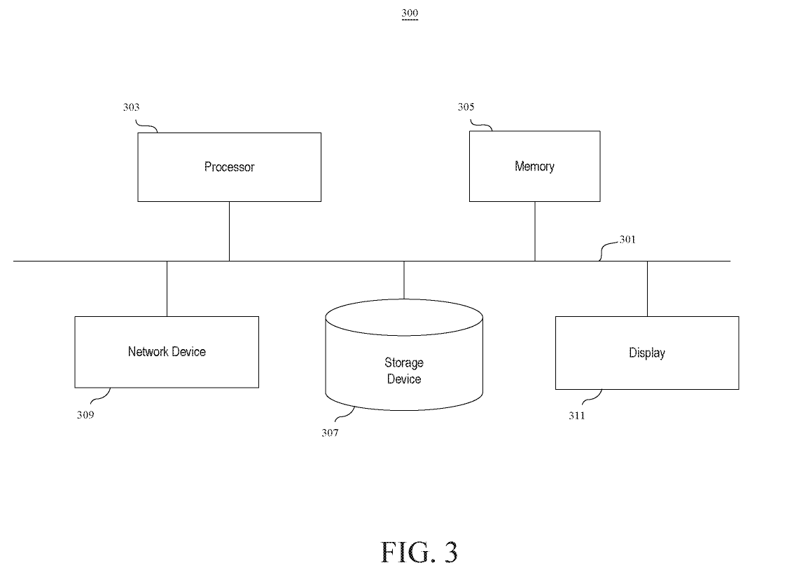

FIG. 3 is a block diagram illustrating an exemplary computing device 300 designed to assist automatic non-emergency call handling is depicted. The computing device 300 may include processor 303, such as, for example, a central processing unit (CPU). A CPU may be a hardware component responsible for executing instructions of a computer program. The CPU may perform arithmetic and logic operations, manage data storage and retrieval, and control input and output devices.

In some embodiments, processor 303 may include, or may be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), application-specific integrated circuit (ASIC), controllers, state machines, gated logic, discrete hardware components, dedicated hardware finite state machines, a server, a virtual server, or other circuits suitable for executing instructions or performing logic operations. In some embodiments, processor 303 may include more than one processor. Processors in the more than one processor may be separate circuits or integrated in a single circuit. When more than one processor is used, the processors may be configured to operate independently or collaboratively and may be co-located or located remotely from each other. The processors may be coupled electrically, magnetically, optically, acoustically, mechanically or by any other means that permit them to interact. The processor such as processor 303 may be coupled via a bus 301 to a memory 305. A bus may refer to a communication pathway or set of conductors that may enable multiple components or devices to exchange data and signals within the circuit.

Memory 305 may include a memory portion that may contain instructions that when executed by processor 303, may perform the methods described herein. Memory 305 may be further used as a working scratch pad for processor 303 or a temporary storage. Memory 305 may be a volatile memory such as, but not limited to, random access memory (RAM), and/or non-volatile memory (NVM), such as, but not limited to, flash memory. In some embodiments, memory 305 may include a Read-Only Memory (ROM), a hard disk, an optical disk, a magnetic medium, other permanent, fixed, or volatile memory, or any other mechanism capable of storing instructions. As used herein, a memory may be any type of physical memory in which information or data readable by at least one processor may be stored. The term “memory” (e.g., memory 305) may refer to multiple structures, such as a plurality of memories or computer-readable storage media located within an input unit or at a remote location.

Processor 303 may be further connected to a network device 309, such as a network interface card (NIC), for providing connectivity between the computing device 300 and a network. A NIC may be a hardware component that enables a computer or other device to connect to a network, providing a physical interface for the transmission and reception of data over the network.

Processor 303 may be further coupled with a storage device 307. Storage device 307 may be used for storing a wide variety of data, including but not limited to, single data type column-oriented data structures, complex multi-type data structures, individual data elements, metadata, configuration files, logs, images, documents, and any other digital content, consistent with disclosed embodiments. For example, storage device 307 may include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or any type of storage device. The codes and data may include an operating system (OS) and one or more application programs (“apps”) for specific tasks. While illustrated in FIG. 3 as a single device, it is to be understood that storage device 307 may include multiple devices either collocated or distributed. Storage device 307 may also be a virtual memory that includes one or more storage devices distributed across multiple machines or devices coupled via a network. Disclosed embodiments may include and/or access a data structure as described elsewhere in this disclosure. A data structure may be a component of system 300, a component of storage 307, or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. Thus, the term “data structure” as used herein in the singular is inclusive of plural data structures.

As shown in FIG. 3, computing device 300 may include display 311. Display 311 may be a computer screen, a phone screen, a tablet screen, interactive display, augmented reality (AR), virtual reality (VR) display, or any other structure capable of displaying data. Display 311 may include a user interface, such as a computer with a keyboard and mouse, or a touch screen.

Various embodiments are described herein with reference to a system, method, device, or computer-readable medium. It is to be understood that disclosure of a computer-readable medium described herein also constitutes a disclosure of methods implemented by the computer-readable medium, and systems and devices for implementing those methods, via for example, at least one processor (e.g., processor 303). It is to be understood that this form of disclosure is for ease of discussion only, and one or more aspects of one embodiment herein may be combined with one or more aspects of other embodiments herein, within the intended scope of this disclosure.

As a whole, the disclosed systems and methods may provide improvements for non-emergency call handling because the systems and methods allow reporting parties to report and resolve incidents without calling in, waiting on hold, speaking to a dispatcher, and reporting to the dispatcher who may tell them that they could report online. Without tying up the dispatchers in PSAPs to answer the calls even if reporting parties ultimately end up reporting their incidents online, the disclosed systems and methods may automatically handle the calls and direct reporting parties to appropriate procedures for reporting their non-emergencies without engaging the dispatchers. The systems’ structure and built-in mechanisms for sorting and processing non-emergency calls automatically may help to ensure better efficiency and effectiveness in call handling in PSAPs by alleviating challenges in managing and responding to high call volume compared to the conventional method of answering most of the calls from reporting parties. The disclosed systems and methods may also provide a solution to the problem of PSAPs being understaffed to handle high call volumes.

The disclosed embodiments are not limited to the above-described examples, but instead are defined by the appended claims in light of their full scope of equivalents. Moreover, while illustrative embodiments have been described herein, the scope includes any and all embodiments having equivalent elements, modifications, omissions, combinations (e.g., of aspects across various embodiments), adaptations, or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps or inserting or deleting steps.

It is intended, therefore, that the specification and examples be considered as examples only, with a scope indicated by the following claims and their full scope of equivalents.

What is claimed is:

1. A computer-implemented system for automatic non-emergency call handling, comprising:
a memory storing instructions; and
at least one processor configured to execute the instructions to:
receive a call regarding an incident from a reporting party via a reporting party device;
initiate a response input component to determine if the call is regarding a non-emergency incident;
transmit a link to an online incident reporting application to the reporting party device upon the response input component determining that the call is regarding a non-emergency incident;
route the call to an artificial intelligence component if the response input component is not able to determine if the call is regarding a non-emergency incident, the artificial intelligence component configured to gather further information relating to the call;
determine, using the artificial intelligence component and the gathered further information, if the call is regarding a non-emergency incident;
transmit the link to the online incident reporting application to the reporting party device upon the artificial intelligence component determining that the call is regarding a non-emergency incident; and
transfer the call to an external system if the artificial intelligence component is not able to determine if the call is regarding a non-emergency incident.

2. The computer-implemented system of claim 1, wherein the at least one processor is further configured to execute the instructions to:
receive, if the call is regarding a non-emergency incident, the non-emergency incident information from the reporting party device;
assign metadata including timestamps and device type associated with the non‑emergency incident information; and
store the incident information in a database via a records management component.

3. The computer-implemented system of claim 1, wherein the at least one processor is further configured to execute the instructions to:
generate, if the call is regarding a non-emergency incident, a corresponding dispatchable incident record via a computer-aided dispatch component.

4. The computer-implemented system of claim 3, wherein the computer-aided dispatch component is further configured to export the dispatchable incident record to one or more external public safety systems.

5. The computer-implemented system of claim 1, wherein the response input component is an interactive voice response system.

6. The computer‑implemented system of claim 1, wherein the call is received via a public switched telephone network, a wireless cellular network, or a Voice over Internet Protocol network.

7. The computer-implemented system of claim 1, wherein the online incident reporting application is further configured to receive multimedia content from the reporting party device, including one or more of images, audio files, or video files.

8. The computer-implemented system of claim 1, wherein the artificial intelligence component is a virtual contact center supported by generative machine-learning agents.

9. The computer-implemented system of claim 1, wherein the artificial intelligence component is further configured to evaluate reporting party intent using a machine‑learning model trained on public safety answering point (PSAP) call data.

10. The computer-implemented system of claim 1, wherein the at least one processor is further configured to log each routing decision, including determinations made by the response input component and the artificial intelligence component, in a database.

11. The computer‑implemented system of claim 1, wherein the at least one processor is further configured to bypass automatic non-emergency call handling and transfer the call out of the system in response to receiving an input indicating selection of a live dispatcher from the reporting party device.

12. The computer‑implemented system of claim 1, wherein the at least one processor is further configured to transfer the call out of the system after a predetermined number of unanswered prompts.

13. A computer-implemented method for automatic non-emergency call handling, the method comprising:
receiving a call regarding an incident from a reporting party via a reporting party device;
initiating a response input component to determine if the call is regarding a non-emergency incident
transmitting a link to an online incident reporting application to the reporting party device upon the response input component determining that the call is regarding a non-emergency incident;
routing the call to an artificial intelligence component if the response input component is not able to determine if the call is regarding a non-emergency incident, the artificial intelligence component configured to gather further information;
determining, using the artificial intelligence component and the gathered further information, if the call is regarding a non-emergency incident;
transmitting the link to the online incident reporting application to the reporting party device upon the artificial intelligence component determining that the call is regarding a non-emergency incident; and
transferring the call to an external system if the artificial intelligence component is not able to determine if the call is regarding a non-emergency incident.

14. The computer-implemented method of claim 13, further comprising:
receiving, if the call is regarding a non-emergency incident, the non-emergency incident information from the reporting party device;
assigning metadata including timestamps and device type associated with the non‑emergency incident; and
storing the incident information in a database via a records management component.

15. The computer-implemented method of claim 13, further comprising:
generating, if the call is regarding a non-emergency incident, a corresponding dispatchable incident record via a computer-aided dispatch component.

16. The computer-implemented method of claim 15, further comprising:
exporting, by the computer-aided dispatch component, the dispatchable incident record to one or more external public safety systems.

17. The computer-implemented method of claim 13, wherein the response input component is an interactive voice response system.

18. The computer‑implemented method of claim 13, wherein the call is received via a public switched telephone network, a wireless cellular network, or a Voice over Internet Protocol network.

19. The computer-implemented method of claim 13, wherein the artificial intelligence component is a virtual contact center supported by generative machine-learning agents.

20. The computer-implemented method of claim 13, further comprising:
receiving, by the online incident reporting application, multimedia content from the reporting party device, including one or more of images, audio files, or video files.
